(19) United States
(12) Patent Application Publication
(10) Pub. No.: US 2022/0011847 A1
(43) Pub. Date: Jan. 13, 2022

(54) INFORMATION PROCESSING APPARATUS AND CONTROL METHOD IN INFORMATION PROCESSING APPARATUS

(71) Applicant: FUJITSU LIMITED, Kawasaki-shi (JP)

(72) Inventor: Akihiro SENOO, Arakawa (JP)

(73) Assignee: FUJITSU LIMITED, Kawasaki-shi (JP)

(21) Appl. No.: 17/327,815

(22) Filed: May 24, 2021

(30) Foreign Application Priority Data
Jul. 9, 2020 (JP) 2020-118546

(51) Int. Cl. G06F 1/3234; G06F 1/3296; G06F 1/3228; G06F 11/30

(52) U.S. Cl. CPC G06F 1/3243; G06F 11/3062; G06F 1/3228; G06F 1/3296

(57) ABSTRACT

An information processing apparatus includes: a memory; and a processor coupled to the memory and configured to: measure power consumption of the processor; measure performance of the processor; detect a decrease in power efficiency of the processor, based on the power consumption of the processor measured during execution of a program; in response to detection of a decrease in the power efficiency, execute the program while changing an operation parameter of the processor; and determine a setting value of the operation parameter, based on the power consumption and the performance of the processor that are measured during execution of the program while the operation parameter is being changed.

### CROSS-REFERENCE TO RELATED APPLICATION

This application is based upon and claims the benefit of priority of the prior Japanese Patent Application No. 2020-118546, filed on Jul. 9, 2020, the entire contents of which are incorporated herein by reference.

### FIELD

The embodiment discussed herein is related to an information processing apparatus and a control method in the information processing apparatus.

### BACKGROUND

Information processing apparatuses (computers) are used in large-scale systems such as a data center and a system for high-performance computing (HPC). To improve the performance of processors in information processing apparatuses, techniques for enhancing the parallel processing performance and techniques for enhancing the single processing performance are evolving.

Related art is disclosed in Japanese Laid-open Patent Publication No. 11-353052 and Japanese Laid-open Patent Publication No. 2012-178173.

### SUMMARY

According to an aspect of the embodiments, an information processing apparatus includes: a memory; and a processor coupled to the memory and configured to: measure power consumption of the processor; measure performance of the processor; detect a decrease in power efficiency of the processor, based on the power consumption of the processor measured during execution of a program; in response to detection of a decrease in the power efficiency, execute the program while changing an operation parameter of the processor; and determine a setting value of the operation parameter, based on the power consumption and the performance of the processor that are measured during execution of the program while the operation parameter is being changed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a multicore processor of the related art;

FIG. 2 is a diagram illustrating a functional configuration of an information processing apparatus;

FIG. 3 is a diagram illustrating a hardware configuration of the information processing apparatus;

FIG. 4 is a diagram illustrating a configuration of a processor;

FIG. 5 is a diagram illustrating coupling relationships between components in the processor;

FIG. 6 is a diagram illustrating a configuration of a performance counter;

FIG. 7 is a diagram illustrating a configuration of a power monitor;

FIG. 8 is a diagram illustrating a configuration of a control processor;

FIG. 9 is a flowchart of a control process;

FIG. 10A is a flowchart (part 1) of a first example of an operation parameter search process;

FIG. 10B is a flowchart (part 2) of the first example of the operation parameter search process;

FIG. 11 is a diagram illustrating operation parameters; and

FIG. 12 is a flowchart of a second example of the operation parameter search process.

### DESCRIPTION OF EMBODIMENTS

The performance of a processor is evaluated by, for example, the number of instructions executed per unit time. A processor may also be referred to as a central processing unit (CPU). The techniques for enhancing the parallel processing performance include multiprocessing, multicore processing, multithreading, and so on. The techniques for enhancing the single processing performance include improvement of microarchitecture.

The scale of parallel processing implemented by multiprocessing, multicore processing, multithreading, or the like is determined depending on a down-sizing level of semiconductors and an amount of materials mountable in dies of processors. When the parallel processing performance is enhanced, the performance of the processors improves but power consumption also increases. However, it is difficult to suppress power consumption while controlling the parallel processing performance by hardware.

As for the single processing, improvement of microarchitecture is sought by enhancement or improvement of resources for out-of-order execution, speculative execution, hardware prefetching, software prefetching, and so on. Similarly to the parallel processing performance, when the single processing performance is enhanced, power consumption of the processor increases, making it difficult to meet the power consumption requisite. However, unlike the parallel processing performance, it is possible to suppress power consumption by controlling the single processing performance by hardware.

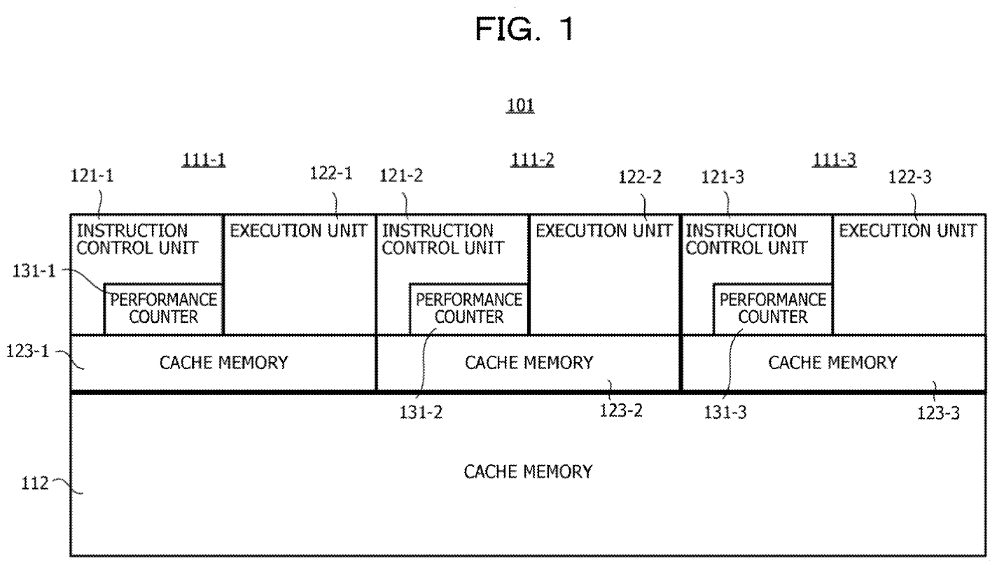

FIG. 1 illustrates an example of a configuration of a multicore processor of the related art. A processor 101 illustrated in FIG. 1 includes cores 111-1 to 111-3 and a cache memory 112. Each core 111-p (where p=1 to 3) includes an instruction control unit 121-p, an execution unit 122-p, and a cache memory 123-p. The instruction control unit 121-p includes a performance counter 131-p.

The instruction control unit 121-p fetches and decodes an instruction included in a program. The execution unit 122-p executes the decoded instruction. The performance counter 131-p counts performance events such as execution of instructions and generates performance information indicating the performance of the core 111-p.

The cache memory 123-p is a dedicated cache memory of the core 111-p. The cache memory 112 is a shared cache memory of the cores 111-1 to 111-3. The cache memory 123-p is a level-1 cache memory. The cache memory 112 is a level-2 cache memory.

Each core 111-p improves the performance of the processor 101 by supporting a plurality of threads. A multiprocessor system is constructed by coupling the plurality of processors 101. The performance of the multiprocessor system improves, compared with the performance of the single processor 101.

In relation to improvement of the performance of a processor, there is known a method for controlling operating speed of a processor by using the number of instructions executed in a user mode by the processor per unit time and the total number of instructions executed by the processor per unit time. There is also known a method of monitoring performance of microarchitecture and tuning the microarchitecture based on the monitored performance.

As described above, overall processing performance may be improved by increasing the degree of integration of a processor or an information processing apparatus. However, since power consumption also increases as the degree of integration increases, it is desirable to suppress the power consumption while improving the performance of the information processing apparatus.

Such an issue occurs in information processing apparatuses of various scales as well as in large-scale systems such as a data center and a system for HPC.

In one aspect, an object of the present disclosure is to improve power efficiency of an information processing apparatus.

An embodiment will be described in detail below with reference to the drawings.

With the recent high integration degree and addition of functions of processors, power consumption of the processors is increasing. On the other hand, a demand for higher performance is rising. Thus, performance per power consumption is preferably maximized. The performance per power consumption refers to a ratio of performance of a processor to power consumption of the processor.

The types of user programs executed by an information processing apparatus are various. Behaviors and features of the user programs are different from one another. Therefore, a method for improving the performance of a processor and suppressing the power consumption of the processor is not uniformly determined, and a method for maximizing the performance per power consumption differs depending on the user program.

Examples of a method for suppressing power consumption include adjustment of an operating frequency of a processor. For example, in a state where a program or the like is not running and a load of a processor is not high, the power consumption is suppressed by keeping the operating frequency low or suppressing a function of making the operating frequency higher than the rated frequency.

The power consumption may be suppressed by reducing the cache size, resources for out-of-order execution, and so on. However, such adjustment of resources of the processor is not open to users in many cases. Even if adjustment of resources is open to users, there is no technique for dynamically changing the resources.

In the technique of Japanese Laid-open Patent Publication No. 11-353052, operation speed of a processor is just controlled, and adjustment of resources of the processor is not performed.

In the technique of Japanese Laid-open Patent Publication No. 2012-178173, performance of microarchitecture is monitored, and the microarchitecture is tuned based on the monitored performance. However, tuning of the microarchitecture is just for performance enhancement and is not intended to suppress power consumption or improve the performance per power consumption.

A method for improving the performance per power consumption by allowing a user to statically change resources of a processor increases the workload of the user. For example, a memory throughput is adjustable by changing an amount of memory mounted in an information processing apparatus. However, to change the amount of memory, work for powering off the information processing apparatus and removing and inserting a memory board occurs.

In a case where the performance per power consumption is maximized while the work of statically changing the resources of the processor and measuring the power consumption is repeated, the workload of the user further increases.

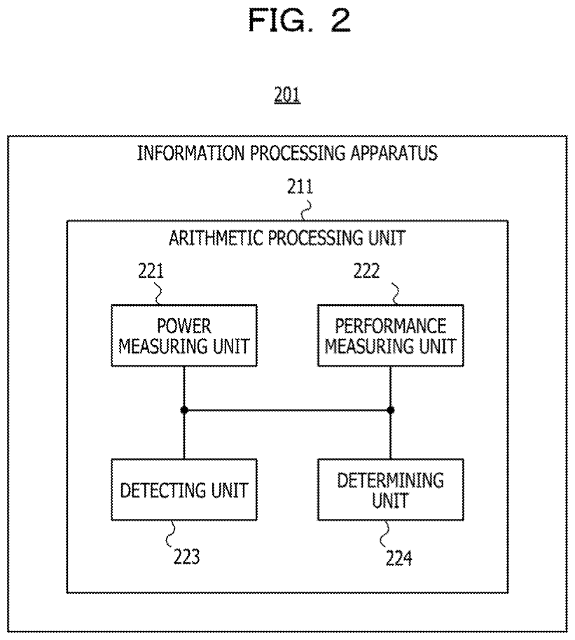

FIG. 2 illustrates an example of a functional configuration of an information processing apparatus according to an embodiment. An information processing apparatus 201 illustrated in FIG. 2 includes an arithmetic processing unit 211. The arithmetic processing unit 211 includes a power measuring unit 221, a performance measuring unit 222, a detecting unit 223, and a determining unit 224.

The power measuring unit 221 measures power consumption of the arithmetic processing unit 211. The performance measuring unit 222 measures performance of the arithmetic processing unit 211. The detecting unit 223 detects a decrease in power efficiency of the arithmetic processing unit 211 based on power consumption of the arithmetic processing unit 211 measured during execution of a program by the arithmetic processing unit 211.

When a decrease in power efficiency is detected, the determining unit 224 causes the arithmetic processing unit 211 to execute the program while changing operation parameters of the arithmetic processing unit 211. The determining unit 224 determines setting values of the operation parameters, based on power consumption and performance of the arithmetic processing unit 211 measured during execution of the program while the operation parameters are being changed.

According to the information processing apparatus 201 illustrated in FIG. 2, the power efficiency of the information processing apparatus 201 may be improved.

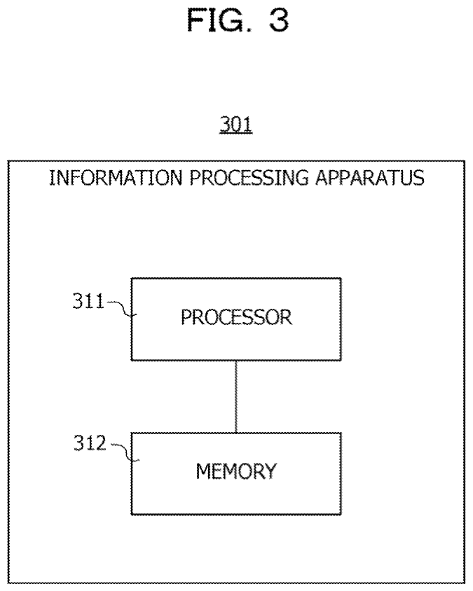

FIG. 3 illustrates an example of a hardware configuration of the information processing apparatus 201 illustrated in FIG. 2. An information processing apparatus 301 illustrated in FIG. 3 is, for example, a server used in a data center, a system for HPC, or the like, and includes a processor 311 and a memory 312, The information processing apparatus 301 further includes a system board (not illustrated) and a power supply (not illustrated). The processor 311 and the memory 312 are hardware.

The processor 311 corresponds to the arithmetic processing unit 211 illustrated in FIG. 2. The memory 312 is, for example, a semiconductor memory such as a random-access memory (RAM). The processor 311 executes a program such as a user program by using the memory 312.

The information processing apparatus 301 may further include an input/output (I/O) controller, an auxiliary storage device, or the like.

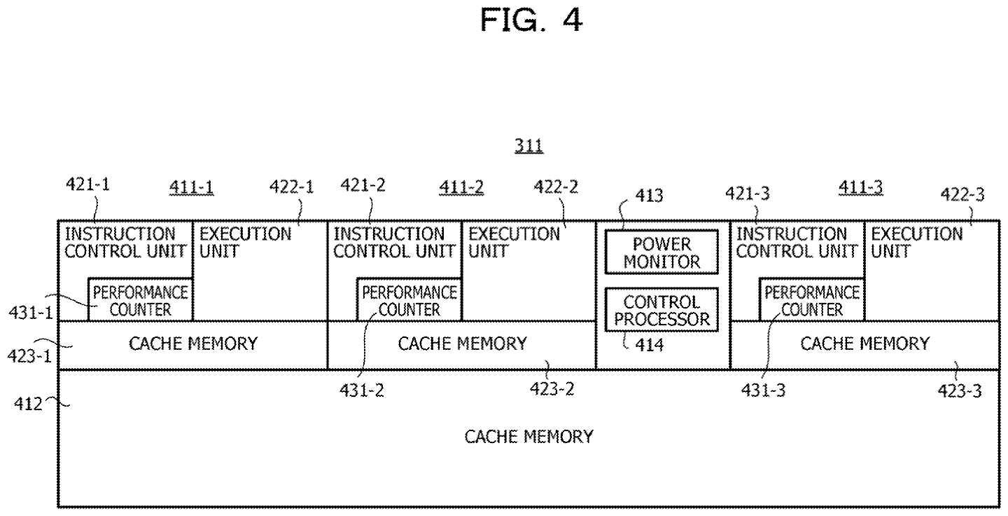

FIG. 4 illustrates an example of a configuration of the processor 311 illustrated in FIG. 3. The processor 311 illustrated in FIG. 4 includes cores 411-1 to 411-3, a cache memory 412, a power monitor 413, and a control processor 414. Each core 411-p (where p=1 to 3) includes an instruction control unit 421-p, an execution unit 422-p, and a cache memory 423-p. The instruction control unit 421-p includes a performance counter 431-p.

The instruction control unit 421-p fetches and decodes an instruction included in a program. The execution unit 422-p executes the decoded instruction. The performance counter 431-p corresponds to the performance measuring unit 222 illustrated in FIG. 2. The performance counter 431-p measures the performance of the core 411-p by counting performance events such as execution of instructions by the core 411-p.

The cache memory 423-p is a dedicated cache memory of the core 411-p. The cache memory 412 is a shared cache memory of the cores 411-1 to 411-3. The cache memory 423-p is a level-1 cache memory. The cache memory 412 is a level-2 cache memory.

The power monitor 413 corresponds to the power measuring unit 221 illustrated in FIG. 2. The power monitor 413 measures power consumption of the cores 411-1 to 411-3 and the cache memory 412. The control processor 414 corresponds to the detecting unit 223 and the determining unit 224 illustrated in FIG, 2. The control processor 414 controls the cores 411-1 to 411-3 and the cache memory 412. The control processor 414 determines optimum setting values of the operation parameters of the processor 311 by using the performance measured by the performance counter 431-p and the power consumption measured by the power monitor 413.

Although the processor 311 illustrated in FIG. 4 includes three cores 411-p, the number of cores 411-p included in the processor 311 may be one, two, or four or more.

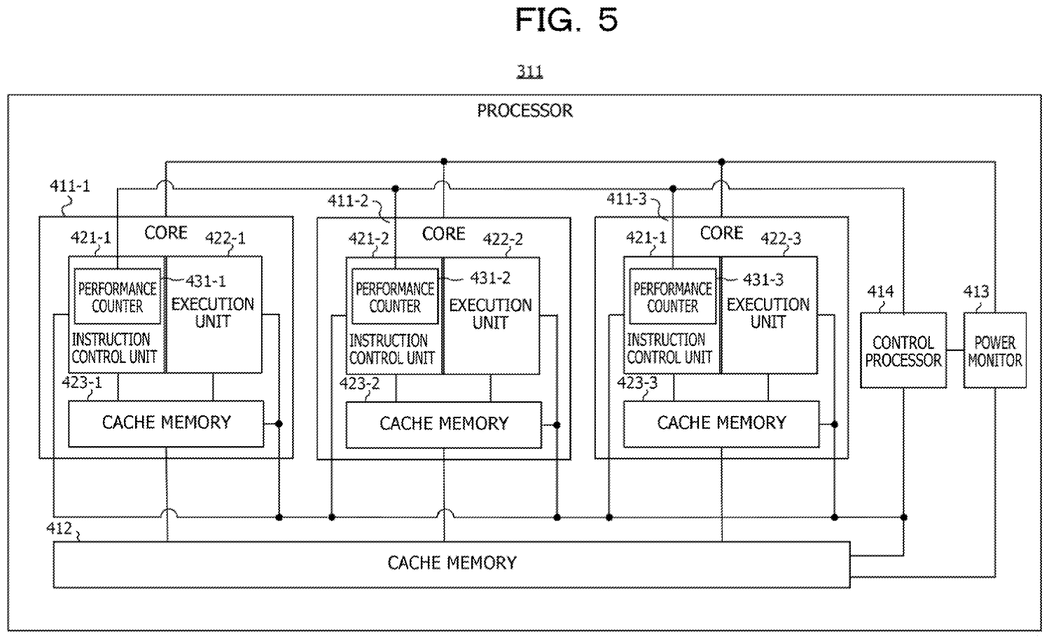

FIG. 5 illustrates coupling relationships between components in the processor 311 illustrated in FIG. 4. The instruction control unit 421-p and the execution unit 422-p in each core 411-p are coupled to the cache memory 423-p. The cache memory 423-p is coupled to the cache memory 412.

The power monitor 413 is coupled to the cores 411-1 to 411-3 and the cache memory 412. The control processor 414 is coupled to the instruction control units 421-1 to 421-3, the execution units 422-1 to 422-3, the cache memories 423-1 to 423-3, and the cache memory 411 The control processor 414 is also coupled to the performance counters 431-1 to 431-3 and the power monitor 413.

The control processor 414 detects a decrease in power efficiency of the processor 311 by using power consumption measured during execution of a program by the cores 411-1 to 411-3. When detecting a decrease in power efficiency, the control processor 414 causes the cores 411-1 to 411-3 to execute the program while changing the operation parameters of the processor 311.

By using the power consumption and the performance that are measured during execution of the program, the control processor 414 searches for setting values of the operation parameters with which the performance per power consumption is maximized. The control processor 414 sets the setting values obtained through the search in the processor 311, and causes the cores 411-1 to 411-3 to execute the program again.

The operation parameters of the processor 311 include a parameter indicating an operating frequency of the processor 311 and parameters of microarchitecture. The operating frequency of the processor 311 indicates the frequency of the clock signal of the cores 411-1 to 411-3. By decreasing the operating frequency, the power consumption of the processor 311 may be suppressed.

The parameters of the microarchitecture include a parameter indicating the size of the resource of the processor 311 and a parameter indicating whether or not to use the resource of the processor 311.

The parameter indicating the size of the resource may be a parameter indicating a single instruction multiple data (SIMD) width, a size of a last-level cache, or a memory throughput. In the case of the processor 311 illustrated in FIGS. 4 and 5, the last-level cache is the cache memory 412. The processor 311 is capable of adjusting the memory throughput by changing the width of a bus between a memory access controller (not illustrated) in the processor 311 and the memory 312.

The parameter indicating whether or not to use the resource may be a parameter indicating whether or not to use pipelines, branch prediction, or prefetching. The pipelines and prefetching are resources of the execution unit 422-p. The branch prediction is a resource of the instruction control unit 421-p.

The power consumption of the processor 311 may be suppressed by reducing the size of the resources in use or stopping the use of any of the resources.

The use frequency of each resource varies depending on the characteristics of a user program executed by the processor 311. Therefore, a combination of the operation parameters with which the performance per power consumption is maximized is not uniformly determined but varies for each user program.

In the processor 311 illustrated in FIGS. 4 and 5, the control processor 414 automatically searches for the combination of the operation parameters with which the performance per power consumption is maximized, and dynamically changes the operation parameters of the processor 311. In this manner, the power efficiency of the information processing apparatus 301 may be improved. When the user program executed by the processor 311 is changed, the combination of the operation parameters is searched for again. In this manner, the combination of the operation parameters suitable for each user program may be obtained.

By dynamically changing the operation parameters, the information processing apparatus 301 no longer has to be powered off, and the workload of the user relating to the change of the operation parameters is reduced. Consequently, the work time decreases.

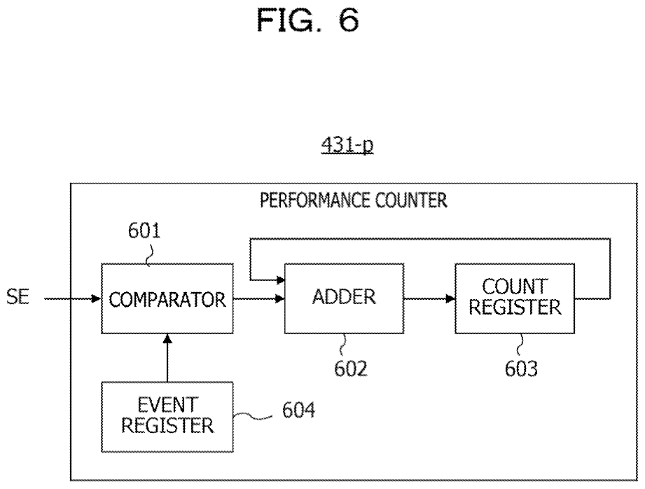

FIG. 6 illustrates an example of a configuration of the performance counter 431-p illustrated in FIGS. 4 and 5. The performance counter 431-p illustrated in FIG. 6 includes a comparator 601, an adder 602, a count register 603, and an event register 604.

The event register 604 stores performance events subjected to measurement. Examples of the performance events subjected to measurement include execution of an instruction by the core 411-p, occurrence of an access to the cache memory 423-p, and so on. A signal SE indicates a performance event that occurs in the core 411-p. The count register 603 stores a count value indicating the number of times the performance events subjected to measurement have occurred. An initial value for the count value is 0.

The comparator 601 compares the performance event stored in the event register 604 with the performance event indicated by the signal SE, and outputs a count-up signal to the adder 602 when the two performance events match. When the count-up signal is output from the comparator 601, the adder 602 increments the count value stored in the count register 603 by 1 .

The performance counter 431-p outputs, to the control processor 414, the count value indicating the number of performance events that have occurred in a predetermined period as performance information indicating the performance of the core 411-p. For example, when the performance events subjected to measurement are execution of instructions, the performance information of the core 411-p may be million instructions per second (MIPS).

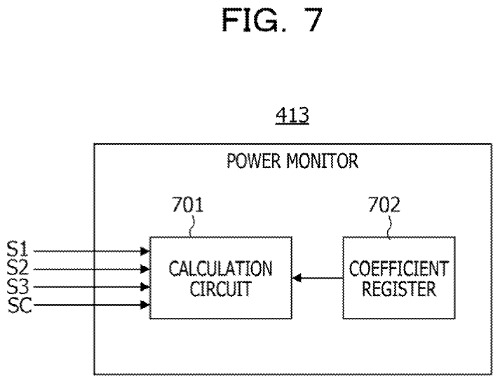

FIG. 7 illustrates an example of a configuration of the power monitor 413 illustrated in FIGS. 4 and 5. The power monitor 413 illustrated in FIG. 7 includes a calculation circuit 701 and a coefficient register 702. Signals S1 to S3 indicate power consumptions of the cores 411-1 to 411-3, respectively. A signal SC indicates power consumption of the cache memory 412. The coefficient register 702 stores coefficients W1 to W3 and a coefficient WC.

The calculation circuit 701 calculates power consumption P of the processor 311 in accordance with Equation (1) by using the signals S1 to S3, the signal SC, the coefficients W1 to W3, and the coefficient WC, and outputs the power consumption P to the control processor 414.

P=S1×W1+S2×W2+S3×W3+SC×WC+C (1)

C is a predetermined constant. For example, in the case of W1=W2=W2=W3=WC=1 and C=0, the power consumption P is calculated in accordance with Equation (2).

P=S1+S2+S3+SC (2)

The power monitor may be disposed in other hardware having large power consumption. For example, by disposing the power monitor in the memory 312 illustrated in FIG. 3, power consumption of the memory 312 may be measured.

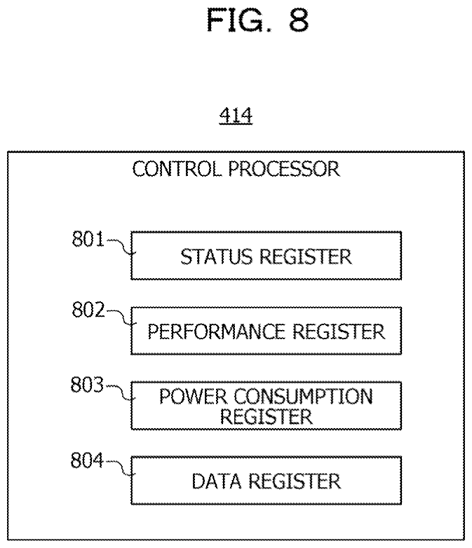

FIG. 8 illustrates an example of a configuration of the control processor 414 illustrated in FIGS. 4 and 5. The control processor 414 illustrated in FIG. 8 includes a status register 801, a performance register 802, a power consumption register 803, and a data register 804.

The status register 801 stores status information indicating an operation mode of the processor 311. The operation mode of the processor 311 is any of a normal mode, a low speed mode, or a search mode. The normal mode is an operation mode in which the processor 311 operates in synchronization with a clock signal having a normal frequency. The low speed mode is an operation mode in which the processor 311 operates in synchronization with a clock signal having a frequency lower than the normal frequency. The search mode is an operation mode in which the processor 311 searches for setting values of the operation parameters with which the performance per power consumption is maximized.

The performance register 802 stores the performance information output from the performance counter 431-p. The power consumption register 803 stores the power consumption output from the power monitor 413. The data register 804 stores an evaluation value indicating the performance per power consumption of the processor 311.

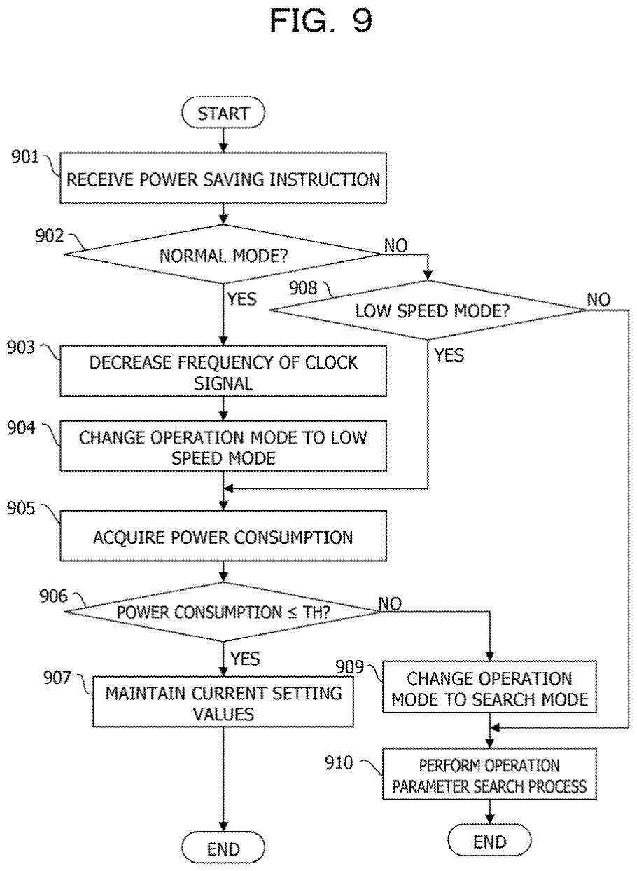

FIG. 9 is a flowchart illustrating an example of a control process performed by the control processor 414 illustrated in FIGS. 4 and 5. The control process illustrated in FIG. 9 is performed while the cores 411-1 to 411-3 are executing a program.

First, the control processor 414 receives, from an operating system (OS), a power saving instruction for switching the operation mode of the information processing apparatus 301 to a low power consumption mode (step 901). The OS operates in any of the cores 411-p, and outputs the power saving instruction to the control processor 414 when the power consumption or load of the information processing apparatus 301 becomes smaller than a predetermined value, for example.

The control processor 414 subsequently checks whether or not the status information stored in the status register 801 indicates the normal mode (step 902). If the status information indicates the normal mode (YES in step 902), the control processor 414 decreases the frequency of the clock signal of the cores 411-1 to 411-3 by a predetermined value F (step 903). The predetermined value F may be a value in a range of 5% to 20% of the normal frequency of the clock signal.

The control processor 414 subsequently changes the status information stored in the status register 801 from the normal mode to the low speed mode (step 904), acquires the power consumption output from the power monitor 413, and stores the power consumption in the power consumption register 803 (step 905). The control processor 414 compares the power consumption stored in the power consumption register 803 with a threshold TH (step 906). The threshold TH may be a value in a range of 40% to 60% of the maximum power consumption of the processor 311.

By decreasing the frequency of the clock signal of the cores 411-1 to 411-3, both the performance and the power consumption of the processor 311 theoretically decrease. However, in a case where the power consumption does not decrease much even when the frequency is decreased by the predetermined value F, there is a possibility that the performance per power consumption of the processor 311 has decreased. Therefore, the power efficiency level of the processor 311 may be checked by comparing the power consumption measured after the frequency of the clock signal is decreased with the threshold TH.

If the power consumption is less than or equal to the threshold TH (YES in step 906), the control processor 414 determines that the power efficiency of the processor 311 has not decreased. The control processor 414 instructs the cores 411-1 to 411-3 and the cache memory 412 to maintain the operation parameters at the current setting values (step 907).

On the other hand, if the power consumption is greater than the threshold TH (NO in step 906), the control processor 414 determines that the power efficiency of the processor 311 has decreased. The control processor 414 changes the status information stored in the status register 801 from the low speed mode to the search mode (step 909).

The control processor 414 subsequently performs an operation parameter search process and sets optimum setting values of the operation parameters in the cores 411-1 to 411-3 and the cache memory 412 (step 910).

If the status information does not indicate the normal mode (NO in step 902), the control processor 414 checks whether or not the status information indicates the low speed mode (step 908). If the status information indicates the low speed mode (YES in step 908), the control processor 414 performs the processing in step 905 and subsequent steps. On the other hand, if the status information indicates the search mode (NO in step 908), the control processor 414 performs the processing in step 910.

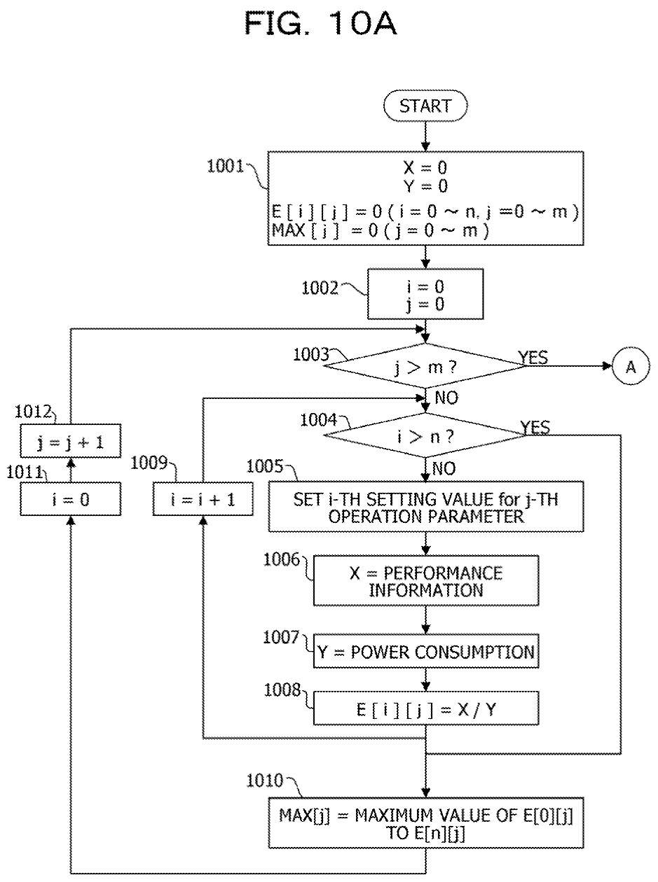

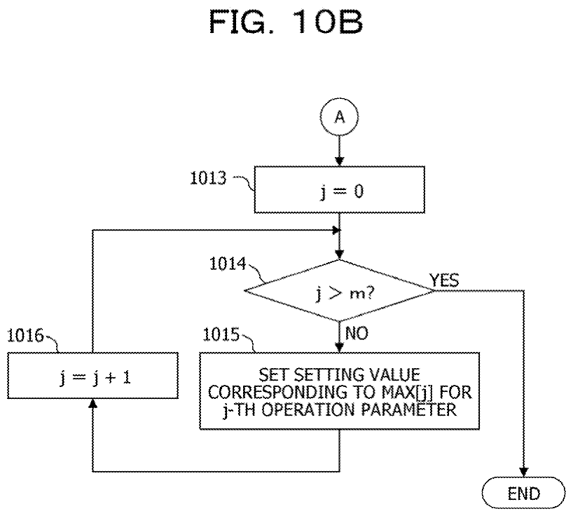

FIGS. 10A and 10B are flowcharts illustrating a first example of the operation parameter search process performed in step 910 of FIG. 9. First, the control processor 414 sets a variable X, a variable V, a variable [i][j] (where i=0 to n and j=0 to m), and a variable MAX[j] (where j=0 to m) to 0 (step 1001).

The variable X represents the performance of the processor 311. The variable Y represents the power consumption of the processor 311. A control variable j represents a j-th operation parameter of the processor 311. A control variable i represents an i-th setting value of each operation parameter. n and m are integers of 0 or greater. Note that n changes depending on the operation parameter. The data register 804 stores 0th to n-th setting values for each operation parameter.

The variable E[i][j] represents the performance per power consumption when the i-th setting value is set for the j-th operation parameter. The variable MAX[j] represents a maximum value among E[0][j] to E[n][j].

The control processor 414 subsequently sets i and j to 0 (step 1002), and compares j and m with each other (step 1003). If j is less than or equal to m (NO in step 1003), the control processor 414 compares i and n with each other (step 1004). If i is less than or equal to n (NO in step 1004), the control processor 414 performs control for setting the i-th setting value for the j-th operation parameter (step 1005).

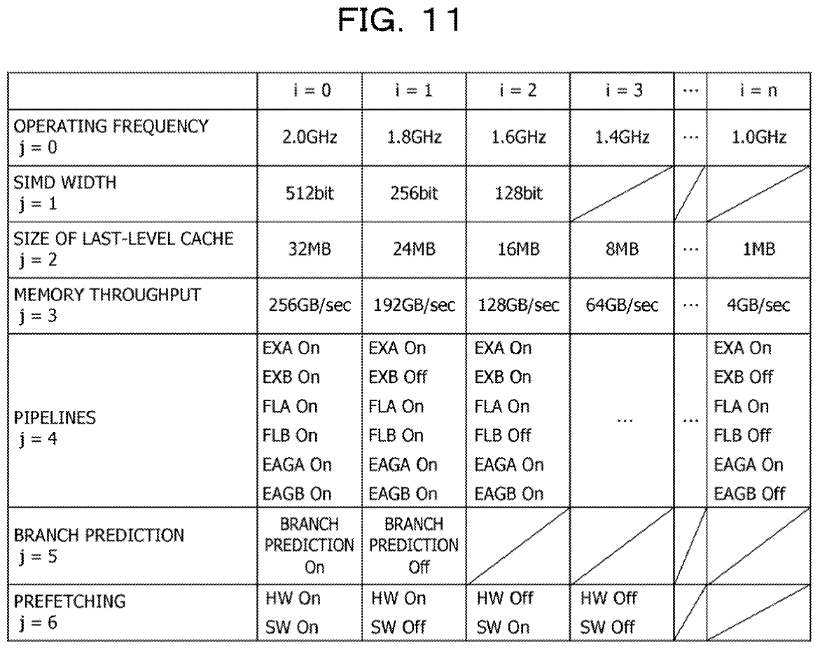

FIG. 11 illustrates an example of the operation parameters in the case of m=6. The 0th operation parameter indicates the operating frequency and has 0th to n-th setting values. For example, the 0th setting value is 2.0 GHz.

The 1st operation parameter indicates the SIMD width and has 0th to 2nd setting values (n=2). For example, the 0th setting value is 512 bits. The 2nd operation parameter indicates the size of the last-level cache and has 0th to n-th setting values. For example, the 0th setting value is 32 MB. The 3rd operation parameter indicates the memory throughput and has 0th to n-th setting values. For example, the 0th setting value is 256 GB/sec.

The 4th operation parameter indicates whether or not to use pipelines and has 0th to n-th setting values. EXA and EXB represent fixed-point arithmetic pipelines FLA and FLB represent floating-point arithmetic pipelines. EAGA and EAGB represent virtual address calculation pipelines for load/store instructions. “On” indicates that the pipeline is used, and “Off” indicates that the pipeline is not used. For example, the 0th setting value has “On” for all the pipelines.

The 5th operation parameter indicates whether or not to use branch prediction and has 0th and 1st setting values (n=1). “On” indicates that branch prediction is used, and “Off” indicates that branch prediction is not used. The 0th setting value is “On”, and the 1st setting value is “Off”.

The 6th operation parameter indicates whether or not to use prefetching and has 0th to 3rd setting values (n=3). HW represents hardware prefetching, and SW represents software prefetching. “On” indicates that prefetching is used, and “Off” indicates that prefetching is not used. For example, the 0th setting value has “On” for HW and SW.

The control processor 414 selects the i-th setting value for the j-th operation parameter stored in the data register 804 and outputs the setting value to the cores 411-1 to 411-3 or the cache memory 412. The cores 411-1 to 411-3 or the cache memory 412 changes the operation parameter to the setting value output from the control processor 414 without stopping the operation.

The control processor 414 subsequently requests the performance counters 431-1 to 431-3 to provide the performance information, acquires the performance information output from the performance counters 431-1 to 431-3, and stores the performance information in the performance register 802. The control processor 414 obtains a statistical value of the performance information acquired from the performance counters 431-1 to 431-3 and sets the statistical value as X (step 1006), As the statistical value, an average, a median, or the like is used.

The control processor 414 subsequently requests the power monitor 413 to provide the power consumption, acquires the power consumption output from the power monitor 413, and stores the power consumption in the power consumption register 803. The control processor 414 sets the power consumption stored in the power consumption register 803 as Y (step 1007).

The control processor 414 subsequently obtains the performance per power consumption by dividing X by Y, and sets the performance per power consumption as E[i][ⱼ] (step 1008). The control processor 414 stores E[i][j] in the data register 804.

The control processor 414 subsequently increments i by 1 (step 1009), and repeats the processing in step 1004 and subsequent steps.

If i exceeds n (YES in step 1004), the control processor 414 sets the maximum value of E[0][j] to E[n][j] stored in the data register 804 as MAX[j] (step 1010). The control processor 414 stores MAX[j] and the value of i corresponding to MAX[j] in the data register 804.

The control processor 414 subsequently sets i to 0 (step 1011), increments j by 1 (step 1012), and repeats the processing in step 1003 and subsequent steps.

If j exceeds m (YES in step 1003), the control processor 414 sets j to 0 (step 1013) and compares j and m with each other (step 1014). If j is less than or equal to m (NO in step 1014), the control processor 414 performs control for setting the setting value corresponding to MAX[j] for the j-th operation parameter (step 1015). At this time, the control processor 414 selects the setting value corresponding to MAX[j] by using the value of i stored in the data register 804.

The control processor 414 outputs the setting value corresponding to MAX[j] to the cores 411-1 to 411-3 or the cache memory 412. The cores 411-1 to 411-3 or the cache memory 412 changes the operation parameter to the setting value output from the control processor 414 without stopping the operation.

The control processor 414 subsequently increments j by 1 (step 1016), and repeats the processing in step 1014 and subsequent steps. If j exceeds m (YES in step 1014), the control processor 414 ends the process.

Through the processing in step 1015, for example, the operation parameters illustrated in FIG. 11 are set to the following setting values.

Operating frequency: 1.6 GHz

SIMD width: 128 bits

Size of last-level cache: 16 MB

Memory throughput: 128 GB/sec

Pipeline: EXA On, EXB On, FLA On, FLB On, EAGA On, EAGB On

Branch prediction: On

Prefetching: HW On, SW Off

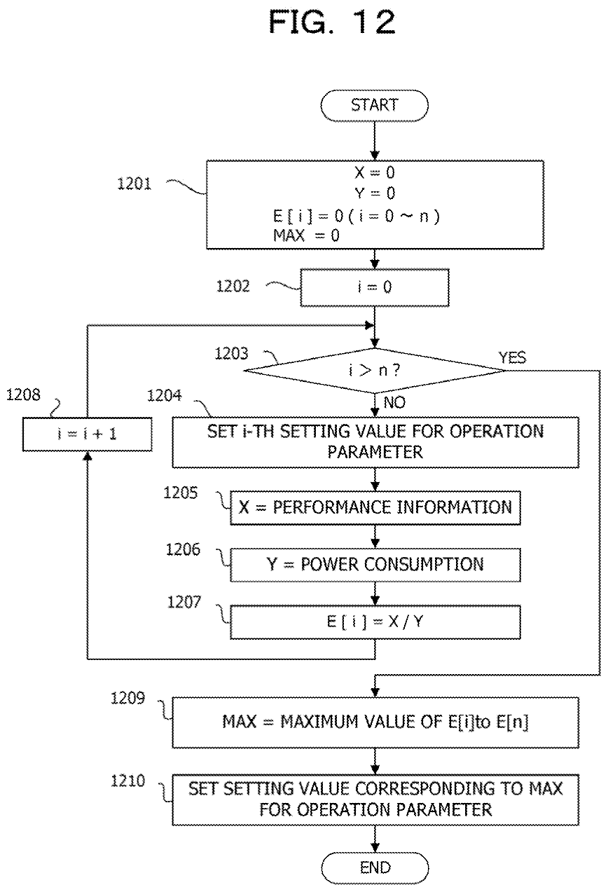

FIG. 12 is a flowchart illustrating a second example of the operation parameter search process performed in step 910 of FIG. 9. In the operation parameter search process illustrated in FIG. 12, an optimum setting value is searched for in terms of a certain operation parameter designated by a user from among the 0th to m-th operation parameters.

First, the control processor 414 sets a variable X, a variable Y, a variable E[i] (where i=0 to n), and a variable MAX to 0 (step 1201). The variable X represents the performance of the processor 311. The variable Y represents the power consumption of the processor 311. The control variable i represents an i-th setting value for the certain operation parameter. The variable E[i] represents the performance per power consumption in a case where the i-th setting value is set for the certain operation parameter. The variable MAX represents a maximum value of E[0] to E[n].

The control processor 414 subsequently sets i to 0 (step 1202) and compares i and n with each other (step 1203). If i is less than or equal to n (NO in step 1203), the control processor 414 performs control for setting the i-th setting value for the certain operation parameter (step 1204).

The processing in steps 1205 and 1206 is substantially the same as the processing in steps 1006 and 1007 of FIG. 10A. The control processor 414 subsequently obtains the performance per power consumption by dividing X by Y, and sets the performance per power consumption as E[i] (step 1207). The control processor 414 stores E[i] in the data register 804.

The control processor 414 subsequently increments i by 1 (step 1208), and repeats the processing in step 1203 and subsequent steps.

If i exceeds n (YES in step 1203), the control processor 414 sets the maximum value of E[0] to E[n] stored in the data register 804 as MAX (step 1209). The control processor 414 stores MAX and the value of i corresponding to MAX in the data register 804.

The control processor 414 subsequently performs control for setting the setting value corresponding to MAX for the certain operation parameter (step 1210). At this time, the control processor 414 selects the setting value corresponding to MAX by using the value of i stored in the data register 804.

For example, in a case where the certain operation parameter is the SIMD width, depending on the characteristics of the program executed by the processor 311, the performance may not improve even if the SIMD width is increased. In this case, since an increase in the SIMD width leads to an increase in power consumption, there is a possibility that the performance per power consumption improves by decreasing the SIMD width. Through the processing in step 1210, the SIMD width is set to 256 bits, for example.

In place of the control processor 414, any of the cores 411-1 to 411-3 may dynamically change the operation parameters of the processor 311 by performing the control process illustrated in FIG. 9.

The configuration of the information processing apparatus 201 illustrated in FIG. 2 and the configuration of the information processing apparatus 301 illustrated in FIG. 3 are merely examples. Some of the components may be omitted or changed in accordance with the usage or conditions of the information processing apparatuses. For example, the information processing apparatus 301 illustrated in FIG. 3 may include an input device, an output device, or a communication device.

The configuration of the processor 101 illustrated in FIG. 1 and the configuration of the processor 311 illustrated in FIGS. 4 and 5 are merely examples. Some of the components may be omitted or changed in accordance with the usage or conditions of the information processing apparatus. For example, in the processor 311 illustrated in FIGS. 4 and 5, when any of the cores 411-1 to 411-3 performs the control process illustrated in FIG. 9, the control processor 414 may be omitted.

The configuration of the performance counter 431-p illustrated in FIG. 6 and the configuration of the power monitor 413 illustrated in FIG. 7 are merely examples. Some of the components may be omitted or changed in accordance with the usage or conditions of the information processing apparatus. The configuration of the control processor 414 illustrated in FIG. 8 is merely an example. Some of the components may be omitted or changed in accordance with the usage or conditions of the information processing apparatus.

The flowcharts illustrated in FIGS. 9, 10A, 10B, and 12 are merely examples, and part of the processing may be omitted or changed in accordance with the configuration or conditions of the information processing apparatus. The operation parameters illustrated in FIG. 11 are merely examples, and some of the operation parameters may be omitted or changed in accordance with the configuration or conditions of the information processing apparatus.

While the embodiment of the disclosure and advantages thereof have been described in detail, a person skilled in the art may make various changes, additions, and omissions without departing from the scope of the disclosure, which is set forth in the appended claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
measure power consumption of the processor;
measure performance of the processor;
detect a decrease in power efficiency of the processor, based on the power consumption of the processor measured during execution of a program; in response to detection of a decrease in the power efficiency, execute the program while changing an operation parameter of the processor; and
determine a setting value of the operation parameter, based on the power consumption and the performance of the processor that are measured during execution of the program while the operation parameter is being changed.

2. The information processing apparatus according to claim 1, wherein the operation parameter is a parameter that indicates a size of a resource of the processor.

3. The information processing apparatus according to claim 2, wherein the parameter that indicates the size of the resource of the processor a is a parameter that indicates a single instruction multiple data width, a size of a last-level cache, or a memory throughput.

4. The information processing apparatus according to claim 1, wherein the operation parameter is a parameter that indicates whether or not to use a resource of the processor.

5. The information processing apparatus according to claim 4, wherein the parameter that indicates whether or not to use the resource of the processor is a parameter that indicates whether or not to use a pipeline, branch prediction, or prefetching.

6. The information processing apparatus according to claim 1., wherein the processor:
decreases an operating frequency of the processor by a predetermined value during execution of the program, and
determines that the power efficiency has decreased in a case where the power consumption of the processor measured after the operating frequency is decreased by the predetermined value is greater than a threshold.

7. The information processing apparatus according to claim 1, wherein the processor:
obtains a ratio of the performance of the processor to the power consumption of the processor, the performance and the power consumption being measured during execution of the program by using each of a plurality of values of the operation parameter of the processor, and
determines, as the setting value, a value that corresponds to a maximum value of the ratio, among the plurality of values.

8. A control method in an information processing apparatus including a processor, the control method comprising:
detecting a decrease in power efficiency of the processor, based on power consumption of the processor measured during execution of a program by the processor;
in response to detection of a decrease in the power efficiency, causing the processor to execute the program while changing an operation parameter of the processor; and
determining a setting value of the operation parameter, based on the power consumption and performance of the processor that are measured during execution of the program while the operation parameter is being changed.

9. The control method according to claim 8, wherein the operation parameter is a parameter that indicates a size of a resource of the processor.

10. The control method according to claim 9, wherein the parameter that indicates the size of the resource of the processor a is a parameter that indicates a single instruction multiple data width, a size of a last-level cache, or a memory throughput.

11. The control method according to claim 8, wherein the operation parameter is a parameter that indicates whether or not to use a resource of the processor.

12. The control method according to claim 11, wherein the parameter that indicates whether or not to use the resource of the processor is a parameter that indicates whether or not to use a pipeline, branch prediction, or prefetching.

13. The control method according to claim 8, further comprising:
decreasing an operating frequency of the processor by a predetermined value during execution of the program, and
determining that the power efficiency has decreased in a case where the power consumption of the processor measured after the operating frequency is decreased by the predetermined value is greater than a threshold,

14. The control method according to claim 8, further comprising:
obtaining a ratio of the performance of the processor to the power consumption of the processor, the performance and the power consumption being measured during execution of the program by using each of a plurality of values of the operation parameter of the processor, and
determining, as the setting value, a value that corresponds to a maximum value of the ratio, among the plurality of values.
